(19) United States
(12) Patent Application Publication
(10) Pub. No.: US 2014/0183108 A1
(43) Pub. Date: Jul. 3, 2014

(54) SEWAGE WATER DEPURATION PLANT, COMPRISING A VERTICAL REACTOR, WITH IMPROVED NITROGEN TREATMENT

(71) Applicant: H.C. DEVELOPMENT S.R.L., Roma (IT)

(72) Inventors: Massimo PICCOLI, Roma (IT); Ranieri DE FERRANTE, Roma (IT)

(73) Assignee: H.C. DEVELOPMENT S.R.L., Roma (IT)

(21) Appl. No.: 14/142,845

(22) Filed: Dec. 28, 2013

Related U.S. Application Data
(63) Continuation of application No. PCT/IT2012/000199, filed on Jun. 27, 2012.

(30) Foreign Application Priority Data
Jun. 28, 2011 (IT) RM2011A000341

(51) Int. Cl. C02F 3/12

(52) U.S. Cl. CPC C02F 3/1278
USPC 210/96.1

(57) ABSTRACT

The present invention concerns un vertical reactor civil and industrial sewage water depuration plant, of the type comprising, in sequence following the flow of water to be depurated: a section (14) of removal of coarse solids which are present in sewage water to be treated, a denitrification basin (18), an oxidation/homogenization basin (20) on the bottom of which a vertical reactor is positioned (22), provided with a plurality of air and oxygen diffusers and with an air lift (23) taking water from the bottom of the vertical reactor (22) and conveying it to a flotation vessel (25) and subsequently to a battery of lamellar packs and from that to a disinfection section (28) and to the outlet, characterised by comprising a second air lift (24) taking water from the vertical reactor (22) at an intermediate height and conveying it to said flotation vessel (25) or to a different flotation vessel (25) and from this to said battery of lamellar packs and subsequently to said disinfection section (28) and to the outlet, means of hydraulic connection by communicating vessels of said denitrification basin (18) and said oxidation/homogenization basin (20), which can be controlled to pass from an open position to a closed position, oxygenation means (48) of said denitrification basin (18) and oxygenation means (46) of said oxidation/homogenization basin (20), stirring means (51) of said denitrification basin (18) and stirring means (49) of said oxidation/homogenization basin (20), and additionally means of detection of oxygen level which is present in said basins (18, 20), controlling the operation of said first deeper air lift (23) and said second less deep air lift (24), and additionally of said oxygenation means (46, 48) and said stirring means (49, 51).

The present invention relates to a vertical reactor civil and industrial sewage water depuration plant, the function of which is that of make the water after treatment compliant with the regulations.

More in particular, the invention refers to civil and industrial sewage water depuration plants of the type with vertical reactor, with improved characteristic of nitrogen treatment.

In the field of apparatuses allowing for the treatment of civil and industrial sewage water, the best results have been obtained by the introduction of the so called “deep shaft” technology.

Examples of such apparatuses or of similar technologies are described in the following patents DE9304698, EP0552134 and WO/2004/035488 and EP2089329.

According to this type of technology, the depuration of sewage water takes place in a vertical reactor completely buried and covered. More traditional deep shaft depuration plants, with vertical reactors having a diameter of 5-8 m, however, have enormous problems of construction and waterproofing, resulting in serious risks to groundwater, which could be polluted. These problems have severely limited their diffusion, even if these systems present important advantages in terms of space and efficiency compared to conventional depuration plants.

According to the modifications proposed in WO/2004/035488, the size of the reactors can be reduced by up to 50 cm in diameter, providing optimal waterproof, with a depth of 40-70 m, making the biological reaction with activated sludge particularly effective due to the high pressure that is present at such depths due to the hydraulic head. The measures considered allow to dig in the housing of the reactor with a normal drill and to waterproof the work perfectly in a shirt of steel and one of HDPE, as well as cement and gravel.

Such a reduction of the diameter of the reactor is due in particular to an innovative system for air distribution. In fact, after the primary treatments, the water to be purified passes through an equalization tank and then enters the reactor, within which compressed air is distributed which, by operating at pressures from 2 to 8 atmospheres, forms fluidised beds of activated sludge whose efficiency is particularly high. After completing the descent to the bottom of the reactor, and thus be in contact with the air and the fluidized beds, the waters return to the surface by the dragging action exerted by an air pump (air lift) and then pass through a series of steps (energy dissipation, flotation and sedimentation) to complete the depuration process.

Depuration plants that make use of this technology have advantages of both environmental and economical type. In fact, the overall dimensions of this type of plants is much lower (30-50% less) compared to an equivalent traditional active sludge system and is completely buried and covered. Furthermore, the production of biological sludge (which are malodorous and expensive to eliminate) is reduced by 50-80%. The initial cost of these plants is lower than that of activated sludge plants of a traditional type, especially thanks to the lower electric power required and to the very reduced concrete works. In addition, the management cost is at least 30% below: less electricity, less maintenance and less sludge, however, already stabilized.

Installations realised by following the teachings of WO/2004/035488 have also highlighted some problems, such as the fact that, in plants with potential of 20000-30000 inhabitants, to which both the rain water and industrial waste are conveyed, which are particularly harmful to the development and maintenance of the bacterial flora responsible for the purification, the regulation of the recirculation of the sludge floated in the heat sink to the balancing and homogenization basin is very problematic, such operation having to be carried out several times a day and requiring much time, with the consequent use of personnel engaged in simple routine tasks.

A second problem highlighted by this type of system is that for relevant flow rates, the float flows in an irregular manner from bottom to top and thereby impede the transfer of solids from the heat sink to the balance.

Moreover, the great variability of the sewage water conveyed to the facilities creates difficulties in adjustment in the amount of air introduced into the vertical reactor, since the beds of activated sludge devoted to the lowering of biodegradable substances and suspended solids change consistence and position inside of the reactor itself.

Moreover, even if the deep shaft system has proved particularly efficient in the lowering of Biological Oxygen Demand (BOD herein below), i.e. when the pollutants are rich in carbon C, the removal of nitrogen N requested a thorough study which showed that the bacteria (nitosomonas and nitrobacter) designated for the purpose do not bear the stress due to the rapid decrease in pressure that occurs in the reactor air lift. For the treatment of sewage water with concentrations of BOD input even higher than 10000 mg/l, there has been the difficulty of obtaining an exchange of oxygen between the air introduced and the sewage, which leads to a difficulty of growth of activated sludge and a poor quality of the same, resulting in unsatisfactory results.

According to EP2089329 it is proposed to overcome these limitations by providing a vertical reactor civil and industrial sewage water depuration plant, of the type comprising a lifting station of the sewage; a fine screening rotary drum; sand removal, de-oiling, denitrification tanks; a nitrification, biological oxidation, homogenization tank; diffusers of air with oxygen; a vertical reactor; an air lift suitable for recirculating the suspended mud and the slurry taking it at a predefinable depth in said reactor; an air pump inside of said reactor, one or more air and oxygen diffusers inside of said reactor positioned at various levels, one or more high pressure compressors that supply said one or more air diffusers, one or more pipes designed to collect samples of the mixture at different depths, a flotation vessel, one or more openings with motorized and manual adjustable gates for the recirculation of the float formed inside and outside of the flotation vessel; a plurality of lamellar packs in the sedimentation tank, a series of hoppers in the sedimentation tank, a submersible pump for the recirculation of the sludge; a collection well of the floated sludge, and a recirculation pump of the mud under oxidation to the denitrification or dehydration; and in particular by endowing said depuration plant of a lifting flow duct for communicating vessels, connected to a well of recycled sludge, and act to recirculate the suspended mud and the slurry taking it at a depth less than the maximum depth of said air lift in said reactor, solid particles in suspension sufficient to permit the increase of the adhering flora and means of introduction of oxygen (O₂) in said reactor in the case of slurry particularly rich in carbon (C) and/or with concentrations of BOD superior to 500-1000 ppm.

Implants made following the teachings of EP2089329 have demonstrated a remarkable ability to treat sewage water even at the highest level of BOD, producing a very small amount of sludge.

Experience has in fact shown that the action of the air lift, leading to the rapid transition from a pressure of about 7 atm, corresponding to a depth of 60 m, to the atmospheric pressure present in the flotation tank, causes the physical lysis of the bacteria, which is instrumental both in providing feed (by means of recycling) to the incoming bacteria and to reduce the viability of the waste sludge, making them, in effect, more digested and reducing its impact on the nose.

In addition, the systems made according to the teachings of EP2089329 have a good track record on the treatment of nitrogen.

But two facts remain that can not be ignored:
the increasing use of detergents causes a steady increase in the ammoniacal nitrogen content of municipal sewage water, and
the legislation becomes more stringent, with a reduction of the levels allowed outside of the so-called sensitive areas.

These facts make it necessary that the whole technology of sewage sludge using activated muds must prepare for a leap in quality that will ensure operational sustainability, with regard to nitrogen, of the present and future plants.

The purpose of the present invention is therefore to provide a vertical reactor civil and industrial sewage water depuration plant allowing to overcome the limits of the solutions according to the prior art, with particular reference to the treatment of nitrogen.

Further object of the invention is that said depuration plant can be manufactured with substantially limited costs, as far as both production costs and maintenance costs.

Another object of the invention is to provide a vertical reactor civil and industrial sewage water depuration plant which is substantially simple, safe and reliable.

It is therefore a specific object of the present invention a vertical reactor civil and industrial sewage water depuration plant a vertical reactor, of the type comprising, in sequence following the flow of water to be depurated: a section of removal of coarse solids which are present in the water to be treated, a denitrification basin, an oxidation/homogenization basin on the bottom of which a vertical reactor is positioned, provided with a plurality of air and oxygen diffusers and with an air lift taking water from the bottom of the vertical reactor and conveying it to a flotation vessel and subsequently to a battery of lamellar packs and from that to a disinfection section and to the outlet, and additionally comprising a second air lift taking water from the vertical reactor at an intermediate height and conveying it to said flotation vessel or to a different flotation vessel and from this to said battery of lamellar packs and subsequently to said disinfection section and to the outlet, means of hydraulic connection by communicating vessels of said denitrification basin and said oxidation/homogenization basin, which can be controlled to pass from an open position to a closed position, oxygenation means of said denitrification basin and oxygenation means of said oxidation/homogenization basin, stirring means of said denitrification basin and stirring means of said oxidation/homogenization basin, and additionally means of detection of oxygen level which is present in said basins, controlling the operation of said first deeper air lift and said second less deep air lift, and additionally of said oxygenation means and said stirring means.

In particular, according to the invention, said vertical reactor civil and industrial sewage water depuration plant provides for the presence of corps in adherent mass both in the oxidation/homogenization basin and the denitrification basin.

Preferably, according to the invention, said vertical reactor civil and industrial sewage water depuration plant comprises heating means of the water at the bottom of the vertical reactor and means of detection of the temperature at the bottom of the vertical reactor, controlling said heating means of water.

More preferably, always according to the invention, said heating means of the water at the bottom of the vertical reactor comprise pure oxygen feeding means at the bottom of the vertical reactor, as reactant in the esothermal reaction of oxigenation of water and/or a heating system which, through insulated tubes, delivers a hot fluid to a coil at the bottom of said vertical reactor.

In particular, according to the present invention, the temperature at the bottom of said vertical reactor is maintained comprised between 50 and 60° C. and preferably equal and anyway close to 58° C.

Further, according to the invention, said depuration plant comprises a handling system of said vertical reactor allowing for the free movement of the same on a horizontal plan within an external housing sleeve, at the same time assuring the hydraulic insulation of the interspace comprised between said vertical reactor and said external sleeve with respect to the oxidation/homogenization basin, comprising a plurality of rollers or spheres, arranged on the sides of the vertical reactor, on which a flange lays, coupled at the extremity of the vertical reactor, and sealing gaskets, positioned between the flange and the plate.

Last, according to the present invention, said vertical reactor is provided with at least one vertical bulkhead, supported by supporting grids with very large mesh, positioned in the section of the vertical reactor in which bacteria beds form.

The present invention will now be described for illustrative but non limitative purposes, according to its preferred embodiments, with particular reference to the figures of the accompanying drawings, wherein:

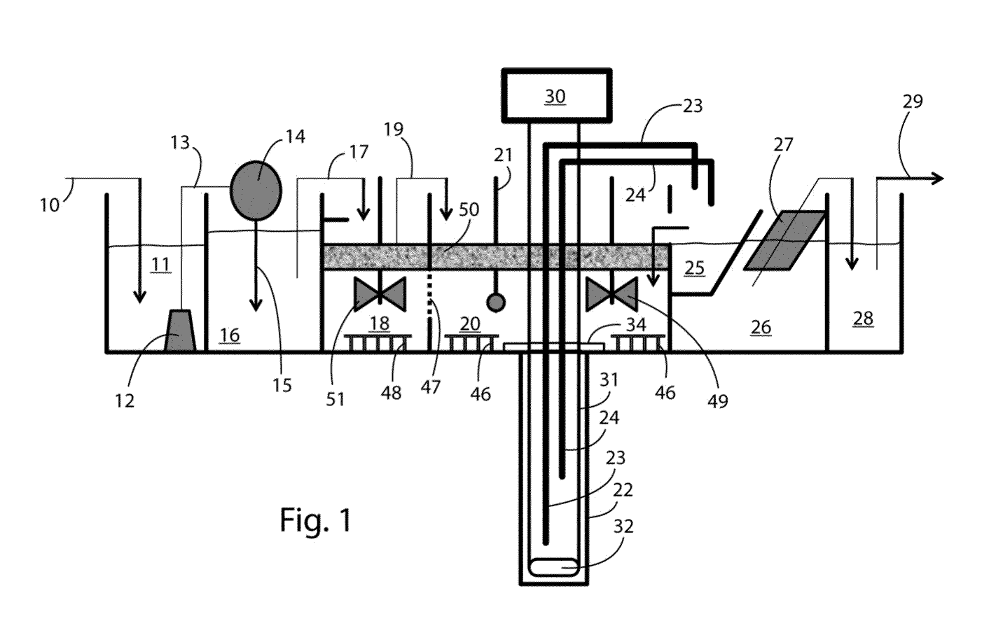

FIG. 1 shows a sectional view of a vertical reactor civil and industrial sewage water depuration plant according to the present invention;

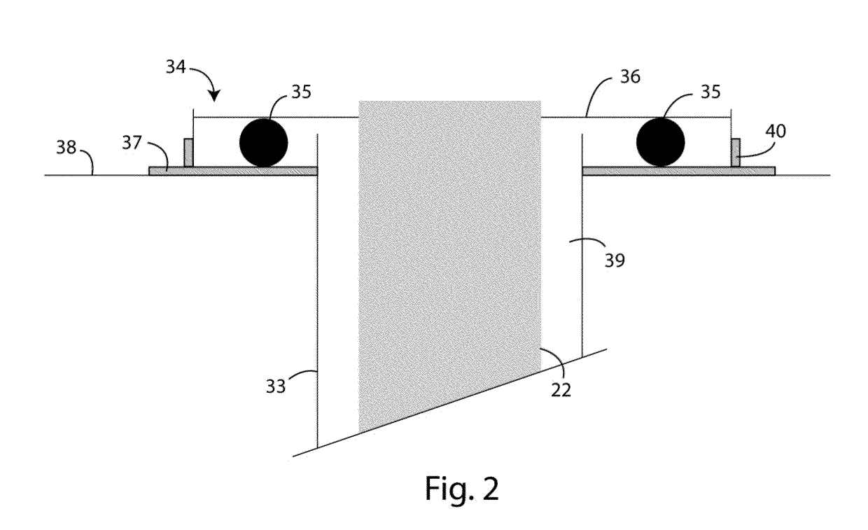

FIG. 2 shows a sectional view of the vertical reactor of the purification plant of FIG. 1, and in particular the seismic flange which is;

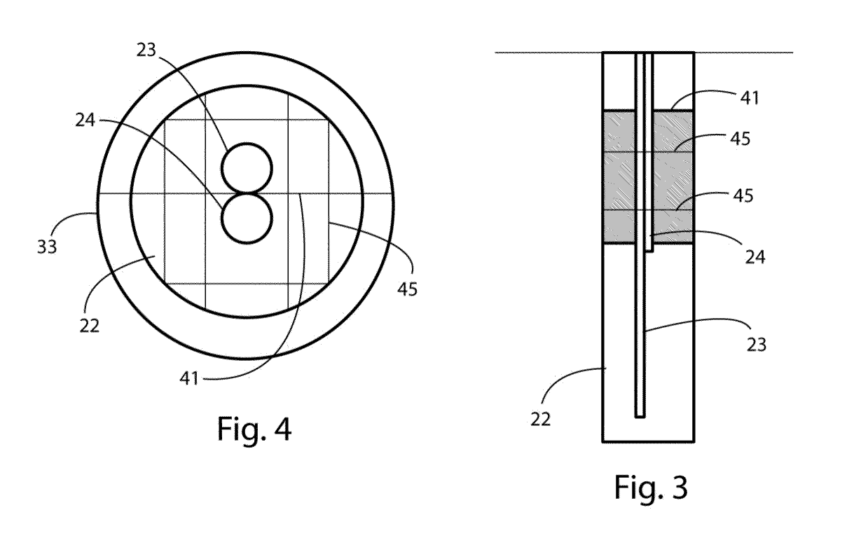

FIG. 3 shows a sectional view of a further embodiment of the vertical reactor of the purification plant of FIG. 1; and

FIG. 4 shows a plan view of the vertical reactor of FIG. 3.

Making first reference to FIG. 1, the sewage coming from a pipe 10 reaches a lifting station 11 in which are installed the pumps 12, which send it through the piping 13 to an apparatus for fine grilling 14 with rotary drum, whose function is to prevent any coarse solid to achieve the subsequent stages and to create clogging and consequent stop of the plant. The material, after the possible compaction, is sent to a waste container (not shown). The sewage at the exit from the fine screening 14 with rotary drum is instead sent, via line 15, to a sand removal de-oiling tank 16, and then sent, via line 17, to the biological denitrification basin 18, accompanied by an agitator 51 and then, via line 19, to an oxidation/homogenization basin 20. In the oxidation/homogenization basin 20 a series of diffusers 46 of air and oxygen dependent on each other are present, and others, which vary depending on the type of sewage to be treated, supplied by blowers with low prevalence. The introduction of air and oxygen causes the mixing of the mass, its biological and chemical oxidation and the dissolution of any other gas additives. On the surface of the oxidation/Homogenization basin 20 are present in adhering mass bodies to increase the area of contact between sewage water and sludge.

In the oxidation/homogenization basin 20 are also present a series of electronic detectors 21 connected to indicators instruments automatically controlling the operating times in the blowers by timer and a series of valves. At the bottom of the oxidation/homogenization basin 20, in plan position variable depending on the characteristics of the sewage to be treated, the vertical reactor 22 is positioned, in which the sewage arrives by gravity, with motion from top to bottom along the entire length of the reactor itself.

Inside the vertical reactor 22 an air pump is installed connected by a vertical pipe (air lift 23) and a series of diffusers of air or oxygen gas positioned at various levels and powered by high pressure compressors.

A second air lift 24 is positioned in the reactor in aid of the first, at an intermediate depth.

The air lift send the water-gas-mud mixture to a flotation vessel 25 equipped with motorized adjustable bulkheads for the execution of the recirculation of the float is formed both within the flotation vessel and in the area outside.

In the tank 26 of the flotation vessel, separated by suitable adjustable motorized bulkheads, the final sedimentation of the plant is made, served by lamellar packs 27, suitably dimensioned and designed, and by a series of hoppers (not shown), which facilitate the outflow of the mud in the area of recovery for the next recirculation with a submersible pump. The recirculation of the float is by gravity.

The resulting water, after passing through the lamellar packs, is sent to a disinfection tank 28 and then sent, via line 29, to discharge.

The plant which has the characteristics of operation described above presents the changes which have already been mentioned at least in part and which are disclosed in detail herein below.

In particular, the solution according to the present invention proposes to improve the ability of this type of system to treat the nitrogen present in the water to be treated.

According to the present invention, this problem is faced with a series of features, which cooperate with each other to obtain the final result.

In the first place, according to the present invention, it is proposed the use of adhering mass bodies in both the oxidation/homogenization basin 20 and in the denitrification basin 18. These adhering mass bodies not only have the function to increase the area of contact between sewage water and sludge, but also and above all, with an action of micro-alternating cycles, thanks to the cycle of destruction and formation of adherent layers, as shown below:
the constant formation of layers 50 of increasing thickness of adhering mass;
following and subsequent anoxic denitrification phase within these layers 50 once the thickness is such as to inhibit the passage of oxygen;
following posting with renewed action of oxygen.

There is evidence that these cycles generally increase the efficiency of activated sludge processes and especially the effectiveness of nitrogen removal.

According to the present invention, this phenomenon is amplified by the introduction of specific changes relative to the denitrification basin 18 and the oxygenation/homogenization basin 20.

Referring again to FIG. 1, in fact, in both said tanks are inserted both oxygenation systems 46, 48 and agitation systems 49, 51 are placed. The tanks are also connected through special windows 47.

The two tanks 18, 20 are then made to operate either as vessels of oxidation/homogenization and as denitrification tanks, controlled by monitoring systems of the levels of oxygen present.

In principle, the step of oxygenation ceases when the oxygen concentration reaches 2 mg/l, whereas the denitrification lasts as long as this value decreases to 0.1 mg/l.

Another trick to improve the treatment capacity of nitrogen is the improvement of the ascent system of the sewage water.

In fact, it is shown that, while it is necessary to make the most of the activity at high depths (its action on carbon and the mud will be described in more detail below), the active bacteria on the nitrogen have great sensitivity to changes in pressure.

Providing that the second air lift 24, with a depth of between 30 and 40 m, enters into action only in correspondence of the denitrification phase at the surface, maximizes the action on nitrogen without penalizing the one on carbon. In fact, if the plant is used in its basic configuration (ie with two dedicated areas, respectively denitrification basin 18 and an oxidation/homogenization basin 20, the shorter air lift 24 allows a certain percentage of waste water not to fully undergo the physical lysis, undergoing a lower pressure drop; if, instead, the operation is chosen alternating between a denitrification phase and an oxygenation phase involving both tanks 18, 20, the operation of the two air lift 23, 24 can be coordinated with the current phase (using the shorter air lift 24 during denitrification and the longest air lift 23 in the step of oxygenation), maximizing the combined result.

Both air lift 23, 24 are inserted into the vertical reactor and operates thanks to the insertion of compressed air at their lower end. The amount of air introduced, and thus the flow of the air lift, is the element that allows the above-mentioned coordinated operation with the action in the surface basin.

The two air lifts are completed by two separate flotation vessel, each in the service of an air lift.

Such flotation vessel can be made not of HDPE, as in the past, but directly of concrete, so as to have greater solidity, not being subject to potential fatigue from vibration and allowing the assembly, on the edge of the overshooting systems for the mud, as well as a lower cost of implementation and a simplification of transport compared to traditional flotation (whose dimensions are very bulky, the order of 5×3×3 m).

In addition to the effects previously described, the solution according to the present invention proposes to improve the ability of this type of plant to treat sewage water even at the highest level of BOD and to produce a negligible amount of mud making the most of the phenomena of lysis of the bacteria that occur within the reactor.

Experience has demonstrated that the rapid transition from a pressure of about 7 atm, corresponding to a depth of 60 meters at the bottom of the vertical reactor, at atmospheric pressure present in the flotation vessel 25 causes a physical lysis of the bacteria, which is instrumental both in providing (by means of recycling) to the bacteria inlet, both to reduce the viability of the waste sludge, making them, in effect, more digested and reducing its impact on the nose.

To this physical lysis, according to the present invention, a thermal lysis is added: it is shown that, at temperatures above 50° C., most of the bacteria undergo this phenomenon. The temperature, however, must not rise above 60° C., the level at which the reaction kinetics decreases substantially.

According to the invention it is proposed to achieve this goal by increasing the temperature at the bottom of the reactor.

This increase in temperature can be obtained in one of two ways, depending on the availability or less of heat sources that can be used:
feeding pure oxygen at the bottom of the reactor;
providing heat at the bottom of the reactor.

For feeding pure oxygen at the bottom of the reactor (however necessary in very small amounts) it is provided the use of a feeding tube to the bottom of the reactor. Thanks to the contribution of oxygen added at the bottom of the reactor, the exothermic chemical reaction of oxygenation, which in itself is already prevalent in that section of the plant, is enhanced to obtain the desired temperature level.

If there is availability of hot water, steam or, in general, thermal energy (for example by virtue of the presence of a transformation system of the biomass in the same plant where the purification plant of the invention is installed), it is instead possible and convenient (as shown in FIG. 1) to use this heat through the installation of a heating system 30 which, through insulated tubes 31, transfers these sources of heat to a coil 32 on the bottom of the vertical reactor 22.

In both the above cases, it is necessary to provide the system with a thermal sensor disposed at the bottom of the vertical reactor, which disengage the heating system in the case where the temperature reaches a threshold level (58° C. appear to correspond to the best result).

The vertical reactor purification system of sewage water and industrial water of the present invention provides for further measures with the aim of introducing seismic precautions and to obtain an increase in the maximum size of the vertical reactor.

The recent seismic phenomena, in fact, have created instinctive concern for the systems, in general, with underground activity.

To overcome these concerns, according to the present invention it is proposed, as an option and to complement the solution already described, a handling system (as shown in FIG. 1 and more in particular in FIG. 2) which allows a certain displacement in horizontal direction of the reactor 22 with respect to its usual position, without generating shear stresses.

The real vertical reactor 22, made of polymeric materials, such as HDPE (high density polyethylene), and surrounded by an external sleeve 33 made of steel, will therefore be equipped with a handling system 34, constituted by rollers 35 or by spheres, arranged on four sides of the vertical reactor 22, on which a flange 36 lays, coupled at the extremity of the vertical reactor 22. The rollers 35 or spheres in turn rest on a plate 37, which in turn rests on the bottom 38 of the oxidation/homogenization basin 20, and which acts as a reinforcement of the bottom 38 itself. Among the reactor 22 and the external sleeve 33 is an interspace 39. According to the prior art, this interspace 39 is isolated with respect to the oxidation/Homogenization basin 20 because the flange 36 is welded to the external sleeve 33. In the case of the solution of the invention, this welding is not feasible because it would prevent the movements of the reactor 22. To ensure the isolation of the interspace 39, according to the present invention, sealing gaskets 40 are provided, positioned between the flanges 36 and the plate 37, sufficiently flexible as not to impede the movements of the reactor 22.

Furthermore, since the horizontal movements due to possible seismic movements would still be equal to a few centimeters, the space between the external sleeve 33 and the reactor 22 is conveniently increased from 10 cm of the known solutions (5 cm per side) up to 20 cm, so as to create a space of movement in which the external sleeve 33 can flex and also deform, without causing shear stresses on the reactor 22, which ensures the hydraulic seal.

As far as the increase in size of the reactor is concerned, the maximum size of the vertical reactors, which reference the embodiments according to the prior art, are equal to about 900 mm in diameter. This limit is imposed by the need to prevent the bacteria beds, increasing its size, to lose stability. This limitation, however, leads to an area of critical issues (including economic) of such plants in the range between 7000 to 11000 inhabitants and over, cases for which we see the need to switch from one to two reactors.

The solution according to the present invention allows to increase the useful diameter of the reactor 22 to 1300 mm (corresponding to an external sleeve 33 equal to 1500 mm), giving then a range of diameters of embodiment from 400 to 1300 mm.

With reference to FIGS. 3 and 4, according to the present invention, the potential destabilization of bacteria beds is eliminated through the introduction of vertical sides 41, integral with two air lift 23, 24, with supporting grids 45 with very large meshes, in the section of the reactor 22 where the bacteria beds are formed (which typically ranges from 10 to 30 feet deep).

This depth can be predetermined, for each installation, based on the amount of air used, the BOD, the amount of suspended solids, the temperature of entry of the sewage water and operating the reactor and other parameters.

The present invention has been described for illustrative but not limitative purposes, according to its preferred embodiments, but it is to be understood that variations and/or modifications can be made by those skilled in the art without departing from the relevant scope of protection, as defined by the claims attached.

1. Vertical reactor civil and industrial sewage water depuration plant, of the type comprising, in sequence following the flow of water to be depurated. an apparatus for fine grilling (14) for removal of coarse solids which are present in sewage water to be treated, a first basin (18) provided with stirring means (51), or denitrification basin (18), a second basin (20) provided with air/oxigen diffusers or oxigenation means (46), or oxidation/homogenization basin (20) on the bottom of which a vertical reactor (22) is positioned, provided with a plurality of air and oxygen diffusers and with an air lift (23) with an inlet at the bottom of the vertical reactor (22) and an outlet to a flotation vessel (25) and subsequently to a battery of lamellar packs and from that to a disinfection section (28) and to the outlet, characterised by comprising a second air lift (24) with an inlet in the vertical reactor (22) at an intermediate height and an outlet to said flotation vessel (25) or to a different flotation vessel (25) and from this to said battery of lamellar packs and subsequently to said disinfection section (28) and to the outlet, one or more hydraulic connections by communicating vessels of said denitrification basin (18) and said oxidation/homogenization basin (20), provided with valves/gates; air/oxigen diffusers or oxygenation means (48) of said denitrification basin (18) and stirring means (49) of said oxidation/homogenization basin (20), and additionally means of detection of oxygen level which is present in said basins (18, 20), in connection with control instruments controlling the operation of said first deeper air lift (23) and said second less deep air lift (24), and additionally of said oxygenation means (46, 48) and said stirring means (49, 51).

2. Vertical reactor civil and industrial sewage water depuration plant according to claim 1, characterised in that it comprises heating means (30, 31, 32) of the water at the bottom of the vertical reactor (22) and means of detection of the temperature at the bottom of the vertical reactor (22), controlling said heating means (30, 31, 32) of the water.

3. Vertical reactor civil and industrial sewage water depuration plant according to claim 2, characterised in that said heating means (30, 31, 32) of the water at the bottom of the vertical reactor (22) comprise pure oxygen feeding means at the bottom of the vertical reactor (22), as reactant in the esothermal reaction of oxigenation of water.

4. Vertical reactor civil and industrial sewage water depuration plant according to claim 2, characterised in that said heating means (30, 31, 32) of the water at the bottom of the vertical reactor (22) comprise a heating system (30) which, through insulated tubes (31), delivers a hot fluid to a coil (32) at the bottom of said vertical reactor (22).

5. Vertical reactor civil and industrial sewage water depuration plant according to claim 1, characterised in that said vertical reactor (22) is provided with at least one vertical bulkhead (41).

6. Vertical reactor civil and industrial sewage water depuration plant according to claim 5, characterised in that said at least one vertical bulkhead (41) is supported by supporting grids (45) with very large mesh.

7. Vertical reactor civil and industrial sewage water depuration plant according to claim 3, characterised in that said heating means (30, 31, 32) of the water at the bottom of the vertical reactor (22) comprise a heating system (30) which, through insulated tubes (31), delivers a hot fluid to a coil (32) at the bottom of said vertical reactor (22).
